(19) United States
(12) Patent Application Publication
(10) Pub. No.: US 2026/0119879 A1
(43) Pub. Date: Apr. 30, 2026

(54) ROBUST, AUTOMATED DATA-DRIVEN MODEL DISCOVERY BASED ON A SAMPLE-LENGTH-SCALING LOGARITHMIC INFORMATION CRITERION

(71) Applicant: Board of Regents, The University of Texas System, Austin, TX (US)

(72) Inventors: Juan GUAN, Austin, TX (US); Michael CHUNG, Austin, TX (US); Alen ZACHARIA, Pittsburgh, PA (US)

(73) Assignee: Board of Regents, The University of Texas System, Austin, TX (US)

(21) Appl. No.: 19/374,624

(22) Filed: Oct. 30, 2025

Related U.S. Application Data
(60) Provisional application No. 63/714,233, filed on Oct. 31, 2024.

(51) Int. Cl. G06N 3/082

(52) U.S. Cl. CPC G06N 3/082

(57) ABSTRACT

A method of training an artificial intelligence model includes obtaining a target matrix, obtaining a library matrix including a library of candidate model terms associated with a plurality of candidate models, and generating, based on the target matrix and the library matrix, a coefficient matrix including estimated model coefficients. The coefficient matrix is pruned based on a pruning matrix of coefficient pruning thresholds to generate at least one sparsified coefficient matrix. One or more of the at least one sparsified coefficient matrix is selected as a candidate to be used by the artificial intelligence model in predicting behavior of a physical system.

### CROSS-REFERENCE TO RELATED APPLICATIONS

This application claims priority to and the benefit of U.S. Provisional Patent Application No. 63/714,233 filed in the United States Patent and Trademark Office on Oct. 31, 2024, the entire contents of which are incorporated herein by reference.

### GOVERNMENT SUPPORT CLAUSE PER 37 CFR 401.14 (F)(4)

This invention was made with government support under Grant no. R35 GM146877 awarded by the National Institutes of Health. The government has certain rights in the invention.

### TECHNICAL FIELD

This application relates generally to modeling physical systems, and more specifically to determining interpretable governing equations using a sample-length-scaling logarithmic information criterion.

### BACKGROUND

Models used by machines implementing artificial intelligence processes may suffer from being excessively biased or having excessive variance. Bias error results from oversimplifying the assumptions used in a model. For example, if a true target function is a quadratic equation, and the user chooses to model such a phenomenon with a linear function, there will be large bias. In contrast, a model with high-level variance may reflect random noise in the training data set instead of the target function.

### SUMMARY

The scope of protection sought for various example embodiments is set out by the appended claims. The example embodiments and/or features, if any, described in this specification that do not fall under the scope of the claims are to be interpreted as examples useful for understanding various embodiments.

The acronym “SLIC” is commonly use to refer to “Simple Linear Iterative Clustering.” Various example embodiments disclosed herein use a particular sample length-scaling logarithmic information criterion, which is also referred to as “SLIC.” Unless otherwise required by context, the term “SLIC” should be understood to refer to the sample-length-scaling logarithmic information criterion disclosed herein.

Essentially every science and engineering discipline uses models (i.e., equations) representing system evolution over time. The models may be used to predict future system operation and/or operation of the system in response to system operating conditions. However, there are many instances under which the model is unknown. At least one example embodiment automatically discovers this unknown model from data. Some such example embodiments outperform conventional techniques of model discovery by extracting accurate (when compared to the ground truth) mathematical governing equations with minimal user intervention, improved noise robustness, and improved computational efficiency. Additionally, various example embodiments are interpretable, in contrast to some conventional artificial intelligence techniques.

For example, neural-network-based approaches often lack interpretability and require large quantities of data to train. One or more example embodiments, return a completely interpretable linear combination of nonlinear functions from a library of candidate nonlinearities. This library of nonlinear functions also constrains the model space, thus requiring far less data to train. Furthermore, the regression-based approach used in various example embodiments is extremely computationally efficient.

In other example embodiments, sparsity enforcement parameters, which have a large impact on algorithm performance, are automatically and adaptively generated these as the model discovery algorithm proceeds. This is in contrast to conventional systems, in which sparsity enforcement is static, and cannot adapt as the algorithm proceeds. Thus, in conventional systems, even if a clear choice of sparsity-enforcing parameters is unknown, the user must still supply a sparsity-enforcing parameters.

Current methodologies for selecting a Pareto-optimal model from candidates are highly prone to overfitting, thus providing a barrier to model generality. Paradoxically, this overfitting becomes more likely as more data is collected. A sample-length-scaling logarithmic information criterion (SLIC) algorithm in accordance with one or more example embodiments respects the fact that models in scientific and engineering disciplines are founded on fundamental principles and should not be prone to overfit as more data is collected. One such SLIC algorithm, which is employed by at least one example embodiment, employs a model-selection criterion that is superior at recovering true models that govern data, across large variations in data quality and quantity.

In various example embodiments, a robust sparse regression algorithm that automatically extracts interpretable governing equations (i.e. system identification) from data via a novel sample length-scaling logarithmic information criterion (SLIC). The algorithm may automatically determine an optimal sparse relationship between outputs/targets (e.g, derivatives) and nonlinear transformations (often called the feature library) of the inputs (e.g. state variable observations). These nonlinear transformations may be supplied by a user, thus permitting expert knowledge to be smoothly integrated into the system identification process. To automate this system identification, some example embodiments iteratively perform one or more rounds of regression to extract an estimate of the system's dynamics, and hard thresholding may be used to eliminate model terms that are nonessential to the dynamics. In various example embodiments, arrays of hard thresholds may be automatically generated from input data, and the optimal threshold may be selected using an information-based model-selection criterion.

A model-selection criterion in accordance with various example embodiments is robust to overfitting, and is closely tied to minimizing model variance (a classic overfitting metric) in the bias-variance tradeoff in machine learning. In at least one example embodiment, the model-selection criterion helps to ensure that models discovered by the algorithm generalize to unseen data. Some example embodiments employ techniques such as Galerkin-projection and ensembling, and simultaneously endow disclosed methods with noise-robustness and uncertainty quantification. Using various techniques, or combinations of techniques disclosed herein, various example embodiments perform robust, system identification using sparse regression and model selection based on an information-based model-selection criterion.

In various example embodiments, a method of training an artificial intelligence model, includes obtaining a target matrix, obtaining a library matrix including a library of candidate model terms associated with a plurality of candidate models, generating, based on the target matrix and the library matrix, a coefficient matrix including estimated model coefficients, pruning the coefficient matrix based on a pruning matrix of coefficient pruning thresholds to generate at least one sparsified coefficient matrix, and selecting one or more of the at least one sparsified coefficient matrix as a candidate to be used by the artificial intelligence model in predicting behavior of a physical system.

In some example embodiments, a method includes generating, from a library matrix including a library of candidate model terms associated with a plurality of candidate models, a coefficient matrix including estimated model coefficients describing dynamic behavior of a physical system, generating a plurality of sparsified coefficient matrices by removing one or more of the estimated model coefficients based on a matrix of sparsity enforcement thresholds, selecting, based on a model-selection criterion that scales with a number of data points, a particular sparsified coefficient matrix of the plurality of sparsified coefficient matrices as optimally describing the dynamic behavior of the physical system, and using the particular sparsified coefficient matrix to model behavior of the physical system.

In further example embodiments, a processing device includes a memory storing a program of instructions, a processor coupled to the memory, and configured to execute the program of instructions to obtain a target matrix, obtain a library matrix including a library of candidate model terms associated with a plurality of candidate models, generate, based on the target matrix and the library matrix, a coefficient matrix including estimated model coefficients, prune the coefficient matrix based on a pruning matrix of coefficient pruning thresholds to generate at least one sparsified coefficient matrix, and select one or more of the at least one sparsified coefficient matrix as a candidate to be used by an artificial intelligence model in predicting behavior of a physical system.

Any or all of the above example embodiments, and other example embodiments disclosed herein, may be used in various combinations to discover interpretable governing equations of physical systems using a sample-length-scaling logarithmic information criterion (SLIC), as described herein.

### BRIEF DESCRIPTION OF THE DRAWINGS

Example embodiments will become more fully understood from the detailed description given herein below and the accompanying drawings, wherein like elements are represented by like reference numerals. The example embodiments are given by way of illustration only, and thus are not limiting of this disclosure.

FIG. 1 is a diagram illustrating model discovery, in accordance with various example embodiments;

FIG. 2 is a diagram illustrating matrices that may be used in model discovery, in accordance with various example embodiments;

FIG. 3 is a flow diagram illustrating model discovery, in accordance with various example embodiments;

FIG. 4 is a diagram illustrating a library matrix including candidate terms used in model discovery, in accordance with various example embodiments;

FIG. 5 is a diagram illustrating an information-based model-selection criterion in accordance with various example embodiments;

FIG. 6 is a diagram illustrating simulated physical systems having true models corresponding to ordinary differential equations (ODEs), in accordance with various example embodiments;

FIG. 7 is a series of graphs illustrating accuracy performance of model discovery techniques applied to the simulated physical systems of FIG. 6, in accordance with various example embodiments;

FIG. 8 is a series of graphs illustrating false-positive performance of model discovery techniques applied to the simulated physical systems of FIG. 6, in accordance with various example embodiments;

FIG. 9 is a diagram illustrating simulated physical systems having true models corresponding to partial differential equations (PDEs), in accordance with various example embodiments;

FIG. 10 is a series of graphs illustrating accuracy performance of model discovery techniques applied to the simulated physical systems of FIG. 9, in accordance with various example embodiments;

FIG. 11 is a series of graphs illustrating false-positive performance of model discovery techniques applied to the simulated physical systems of FIG. 9, in accordance with various example embodiments;

FIG. 12 is a diagram of a sloshing tank, in accordance with various example embodiments;

FIG. 13 is a diagram illustrating comparison of manually fitting a Duffing Oscillator and discovery of the duffing Oscillator model using techniques provided in accordance with various example embodiments;

FIG. 14 is a series of graphs illustrating amplitude and phase shift performance of a model of the sloshing tank illustrated in FIG. 12 discovered using a method, in accordance with various example embodiments;

FIG. 15 is a diagram illustrating various cluster formation mechanisms and rates, in accordance with various example embodiments;

FIG. 16 is a diagram illustrating automated discovery of a cluster formation model, in accordance with various example embodiments;

FIG. 17 is a series of graphs illustrating correspondence between behavior of a discovered cluster formation model and experimental results, in accordance with various example embodiments;

FIG. 18 is a diagram illustrating use of model discovery in physical system diagnostics, in accordance with various example embodiments;

FIG. 19 is a diagram illustrating use of model discovery for discovery of a control law of a physical system diagnostics, in accordance with various example embodiments;

FIG. 20 is a flowchart illustrating a method of training an artificial intelligence model to predict, analyze, and/or model behavior of a physical system, in accordance with various example embodiments;

FIG. 21 is a flowchart illustrating a method of pruning a coefficient matrix to identify a sparsified coefficient matrix as a candidate for use in predicting, analyzing, and/or modeling behavior of a physical system, in accordance with various example embodiments;

FIG. 22 is a flowchart illustrating a method of modeling behavior of a physical system in accordance with various example embodiments;

FIG. 23 is a block diagram of a computing system in accordance with various example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. It should be understood that there is no intent to limit example embodiments to the particular forms disclosed. On the contrary, example embodiments are to cover all modifications, equivalents, and alternatives falling within the scope of this disclosure. Like numbers may refer to like elements throughout the description of the figures. One or more example embodiments described herein may be combined.

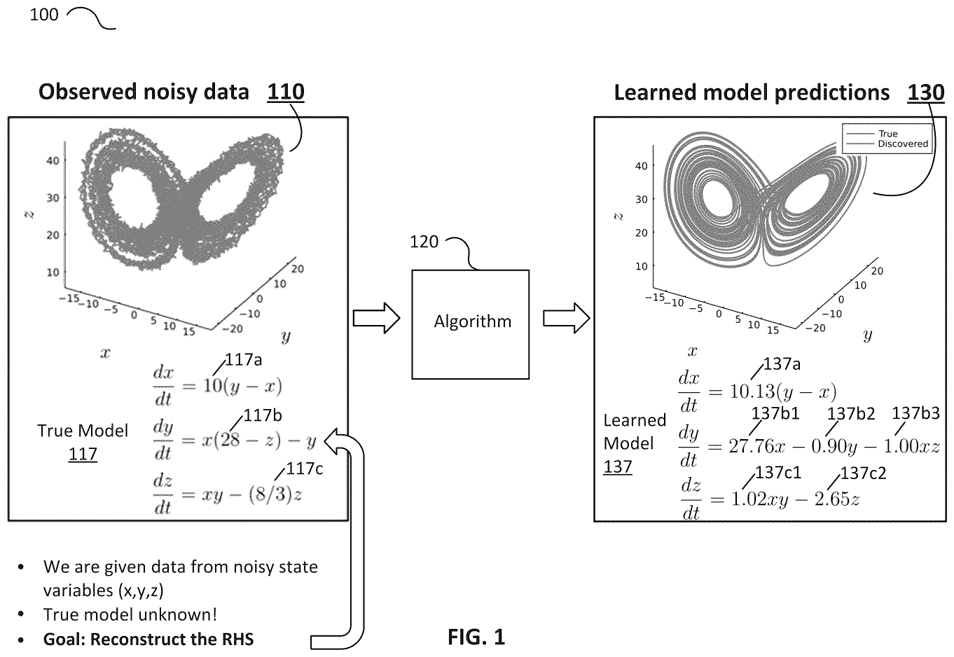

Referring first to FIG. 1, model discovery 100 in which discovery of a model approximating responses of a physical system is discovered, will be discussed in accordance with various example embodiments. In general, a physical system's output may be represented as noisy data 110. A true model 117 of a physical system being modeled may be mathematically represented in an example embodiment by three differential equations with left hand sides of dx/dt, dy/dt, and dz/dt. The goal of the model discovery algorithm is to discover the coefficients 117a, 117b, and 117c on the right hand sides of the three equations. Inputting the noisy data 110 (i.e. the actual values of inputs x, y, z may be unknown) into algorithm 120, algorithm 120 yields a learned model 125 with learned coefficients 137a, 137b1, 137b2, 137b3, 137c1, and 137c2. In various example embodiments, the learned model 137 approximates the true model 117, and may be used to generate learned model predictions 130.

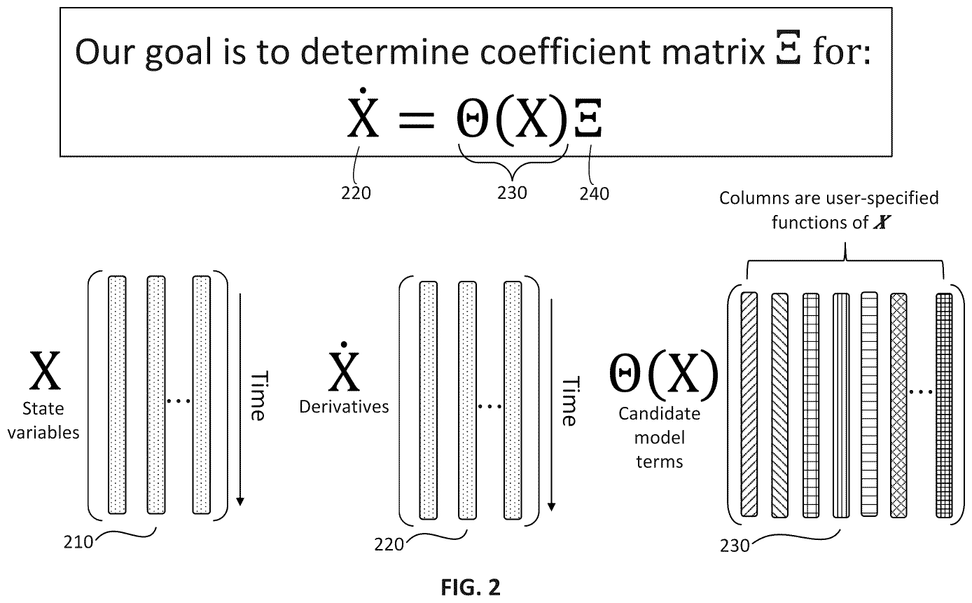

Referring next to FIGS. 2-4, model discovery will be discussed in accordance with one or more example embodiments. In some example embodiments, available data consists of a pair of matrix inputs X=[x₁ . . . xₘ]∈ [symbol] ^{n×m}, and corresponding outputs, Y=[y₁ . . . yₘ]∈ [symbol] ^{n×m}, connected by an unknown mathematical relationship. Here, n denotes the number of observations and m denotes the number of state variables. For example, for an ODE describing a dynamical system, each column of X contains a measured state variable (state variable 210, FIG. 2) over its time course and each column of Y (derivatives 220 shown as \dot{X}, FIG. 2) contains the corresponding numerically estimated time derivatives of the state variables. For time-dependent partial differential equations (PDEs), n is simply the total number of spatiotemporal observations, which scales multiplicatively with the number of dimensions.

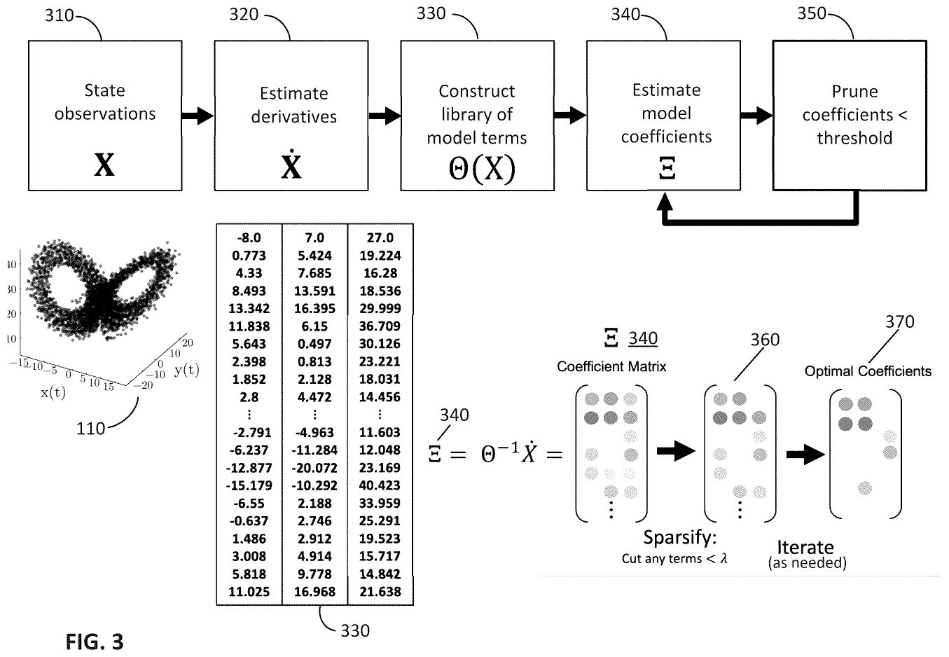

With particular reference to FIG. 3, model discovery will be discussed in further detail in accordance with various example embodiments. In various example embodiments, as illustrated in FIG. 3, an estimated derivative matrix 320 including estimated derivatives of the elements of a state observation matrix 310, is determined. The estimated derivative matrix 320 is also referred to herein as the “target matrix.” In some example embodiments the estimated derivative matrix 320 may be obtained directly by numerically calculating derivatives based on the state observation matrix 310 using difference methods, spline methods, Galerkin methods, and/or other techniques known to those of ordinary skill in the art. In other example embodiments, elements of the target matrix may be measured values.

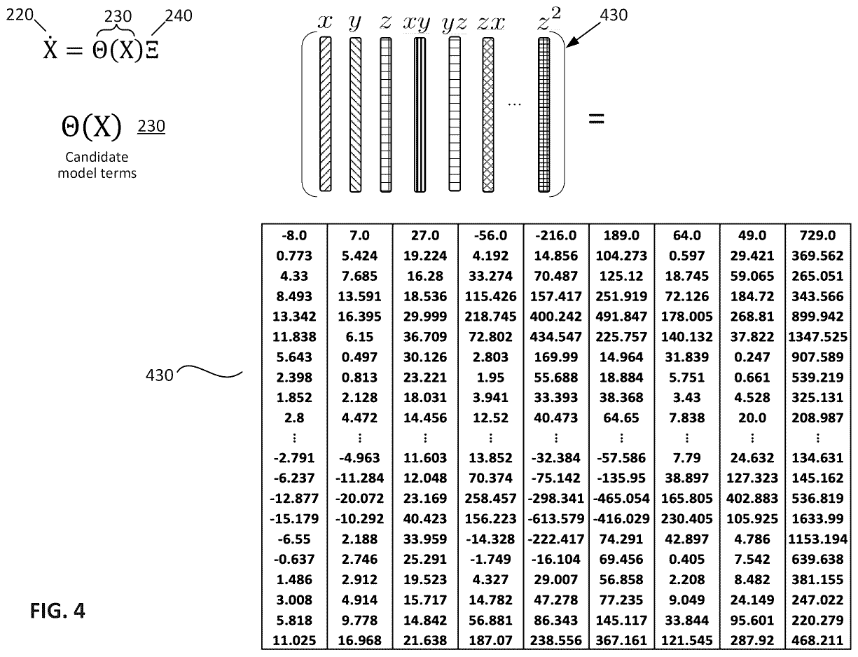

A library of model terms, sometimes referred to herein as a library matrix 330, is constructed based on user input, and used in conjunction with the estimated derivative matrix 320 to generate an estimated model coefficient matrix 340. Note that FIG. 4 illustrates a different library matrix 430 that includes additional candidate model terms, as compared to the library matrix 330 shown in FIG. 3. In at least one example embodiment, the coefficient matrix is determined based on an equation of the form Ξ=Θ⁻¹Y, where Ξ is the coefficient matrix including the estimated model coefficients, Θ⁻¹ is a pseudoinverse of the library matrix including the library of candidate model terms, and Y is the target matrix. In various example embodiments, at block 350 terms less than a pruning threshold, λ, are pruned from the estimated model coefficient matrix 340, for example by setting their value to zero, thereby generating a sparsified coefficient matrix 360. Note that the circles in estimated model coefficient matrix 340, the sparsified coefficient matrix 360, and the iteration-specific optimal coefficient matrix 370 denote non-zero elements, and the blank spaces denote zero elements. As used herein, a “sparsified” matrix refers to a matrix having at least one less non-zero element than a matrix from which the sparsified matrix was generated. A sparsified matrix may be considered to be a sparse matrix. But in at least one example embodiment a sparse matrix may be further sparsified by removing at least one additional non-zero element. In at least one example embodiment, a matrix of pruning thresholds are used to generate multiple sparsified matrices, which are scored to select an iteration-specific optimal coefficient matrix 370. The iteration-specific optimal coefficient matrix may then be sparsified during subsequent iterations of the pruning process, until a final optimal coefficient matrix is selected.

In one or more example embodiments, a particular sparsified coefficient matrix is selected as optimal based on a model-selection criterion, for example based on a ranking in accordance with a model-selection criterion. In some example embodiments, a matrix of pruning thresholds is dynamically generated by determining a maximum absolute value of the estimated model coefficients included in the coefficient matrix, determining a minimum absolute value of the estimated model coefficients included in the coefficient matrix; and generating the pruning matrix based on the maximum and minimum absolute values of the estimated model coefficients.

At least one example embodiment determines the functional relationship between the input and output data of a system, such as a physical system; this functional relationship is is referred to herein as the model, and is used by various example embodiments to model the behavior of a physical system. It should be noted that, as used herein, the term “physical system” includes electrical, To do so, we provide a matrix, Θ(X)=[θ₁(X) θ₂(X) . . . θ₁(X)]∈ [symbol] ^{N×l} whose columns θᵢ(X) are user-specified functions (candidate model terms 230, FIG. 2) of the input data. For example if X=[x₁ x₂]∈ [symbol] ^{n×2} then Θ(X)=[1 x₁ x₂ x₁x₁ x₁x₂ x₂x₂]∈ [symbol] ^{n×6} is a matrix containing all polynomial terms up to 2nd order in X. In the previous example, 1∈ [symbol] ^{n×1} denotes a column vector of one's and the operation x₁x₁ denotes element-wise multiplication.

Now, we assume that our inputs and outputs are related as follows:

$$\begin{matrix}{y}_{1} = {Ξ}_{11} {θ}_{1} ( X ) + {Ξ}_{12} {θ}_{2} ( X ) + ⋯ + {Ξ}_{1 l} {θ}_{l} ( X ) + {η}_{1} \\ ⋮ \\ {y}_{m} = {Ξ}_{m 1} {θ}_{1} ( X ) + {Ξ}_{m 2} {θ}_{2} ( X ) + ⋯ + {Ξ}_{ml} {θ}_{l} ( X ) + {η}_{m}\end{matrix} \qquad ( 1 )$$

Where Ξᵢⱼ are the components of a sparse matrix of coefficients 240 (FIG. 2) to be determined and each ηᵢ is a vector of Gaussian-distributed noise with zero mean. This expression may be concisely represented in matrix form as:

$$Y = Θ ( X ) Ξ + η \qquad ( 2 )$$

To determine Ξ from this equation, we utilize the following optimization problem:

$${Ξ}^{︵} = {argmin}_{Ξ} {‖ Y - Θ ( X ) Ξ ‖}_{2}^{2} + {λ}^{2} R ( Ξ ) \qquad ( 3 )$$

Where R(Ξ) is some regularization function to promote sparsity and λ is the concomitant regularization weight parameter. Here we use R(Ξ)=∥Ξ∥₀, which counts the number of nonzero coefficients in Ξ. In the above equation, λ is effectively the parameter that controls the hard thresholding of parameters that fall beneath its magnitude. Thus, in at least one example embodiment, λ is optimally determined using a sample-length-scaling logarithmic information criterion (SLIC) model-selection criterion.

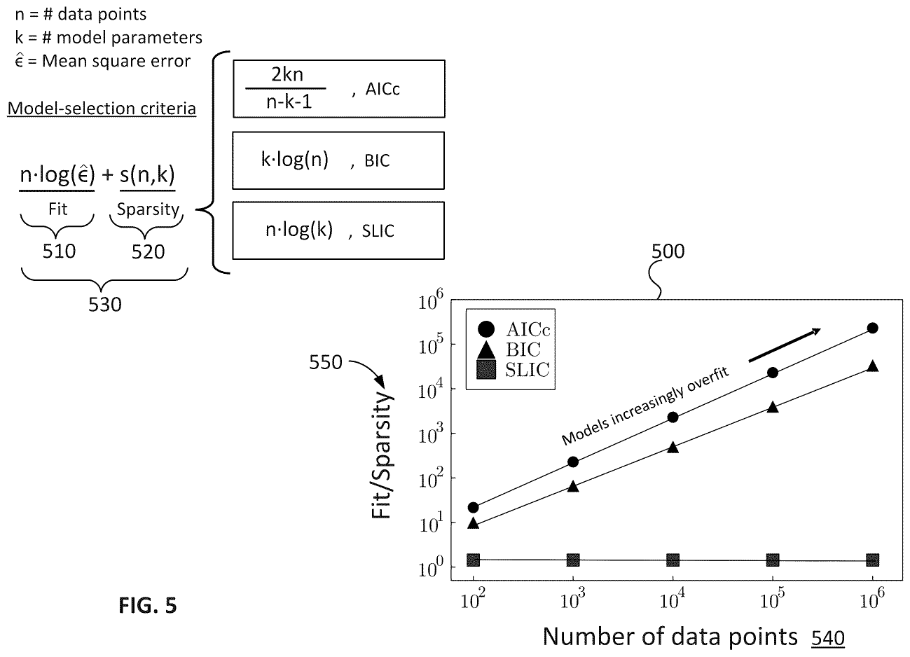

Referring next to FIG. 5, an information-based model-selection criterion for model discovery will be discussed. Many principled methods exist for model selection. Ideal model selection will achieve a balance between parsimony and accuracy in the returned model. One important class of these model selection techniques are known as information-based model-selection criteria, which aim to minimize metrics related to the information content of probability distributions, such as the Kullback-Leibler divergence (KLD). In the case that the underlying data is subject to Gaussian noise, many information criteria (denoted as IC below) take similar forms:

$$IC ( n , k ) = n log ( \hat{ϵ} ) + s ( n , k ) \qquad ( 4 )$$

Where n is the number of observations, k is the number of free parameters in the model (also known as the model complexity, which includes the unknown noise variance), \hat{∈} is the mean square error of the model prediction, which is also the maximum likelihood estimation of the variance of the Gaussian noise, and s(n, k) denotes the sparsity-enforcing component of the information criterion. For AIC (Akaike Information Criterion), s(n, k) is 2 k. For other popular information criteria, such as BIC (Bayesian Information Criterion) and AICc (Akaike Information Criterion, corrected for the low data limit), s(n, k) is k log (n) and

$$\frac{2 kn}{n - k - 1} ,$$

respectively. The Pareto-optimal model that balances goodness of fit with the model complexity, quantified by the number of free parameters, should correspond to the model with the minimum IC score. Thus, depending on the functional form of s(n, k), different information criteria may select different models.

However, a common feature of these information criteria is that as n grows large, the sparsity-enforcing component becomes negligible in comparison to the goodness-of-fit term that scales linearly with

$$n ( i . e . {lim}_{n \to ∞} \frac{n log ( \hat{ϵ} )}{s ( n , k )} = ∞ ) .$$

This may be sensible for certain applications in which model complexity should increase with an increase in collected data, but when the underlying model should be invariant to the amount of collected data, this is clearly not the case.

In fact, it is paradoxical: the returned model is increasingly likely to be overfit (contain incorrect terms) as data quantity increases. To combat such issues, users of conventional systems are required to resort to more complex procedures such as fine-tuning of parameters, data subsampling, etc.

With this in mind, we sought an improved s(n, k), and hence an information-based scoring metric, suitable for the task of model selection in data driven model discovery (DDMD). According to one or more example embodiments, the correct model is assumed to be invariant with respect to collected data. Consequently, it is further assumed that s(n, k) should scale asymptotically with n, i.e. s(n, k)˜n. Using this assumption, without loss of generality, the simplest functional form would be s(n, k)=n log(f(k)), where f(k) is a pure function of the number of free parameters. In turn, this implies that IC(n, k)=n log (\hat{∈}f(k)). In the absence of a priori motivation for this choice, in this work we posit that f(k)∝k. Specifically, we choose f(k)=k, given that the multiplicative factor is superfluous. This choice has several benefits, including satisfying homogeneity and symmetry properties tied to equitable scoring of models.

Interestingly, choosing a model that minimizes this information criterion score is intimately tied to choosing a model that minimizes model variance in the famous bias-variance tradeoff. Conceptually, bias is the error a model incurs by virtue of the modeling choice; if the true data is generated by a quadratic and the user chooses to model such a phenomenon with a linear function, there will be large bias. Generally, more expressive models, which we may consider here as those with more parameters, will have lower bias. Variance, on the other hand, roughly measures the capacity of a model to overfit; this tends to increase with model expressiveness. In a sense, the quality of a model is dictated by the sum of the bias and variance, thus the tradeoff: more expressive models tend to have low bias and higher variance and vice-versa. SLIC, though argued via heuristics from an information-theoretic point of view, is equivalent to minimizing the total variance of the models considered.

As this information criterion scales with sample length and possesses a logarithmic form in k, we refer to it as SLIC, for sample-length-scaling logarithmic information criterion:

$$SLIC ( n , k ) = n log ( \hat{ϵ} ) + n log ( k ) = n log ( k \hat{ϵ} ) \qquad ( 5 )$$

As illustrated in FIG. 5, the term n log(\hat{∈}) is associated with data fit 510, and the term n log (k) 520 is associated with sparsity enforcement. The combination of the two terms is, in at least one example embodiment, the model-selection criterion 530 used to choose an optimal coefficient matrix.

Given the favorable scaling with data quantity, SLIC circumvents the paradox of increasing likelihood of overfitting with data quantity that is manifest in information criteria such as AICc and BIC. Thus, at least one example embodiment, employs an SLIC model-selection criterion within a hard-thresholding sparse regression framework to robustly select an optimal model from an array of λ's (i.e. coefficient pruning thresholds related to sparsity enforcement) that are automatically and adaptively generated as the algorithm proceeds.

As illustrated by graph 500, the tendency to overfit associated with AICc and BIC model-selection criteria increases as the number of data points increases, while the tendency of a SLIC model-selection criterion according to various example embodiments, remains substantially constant-even as the number of data points increases.

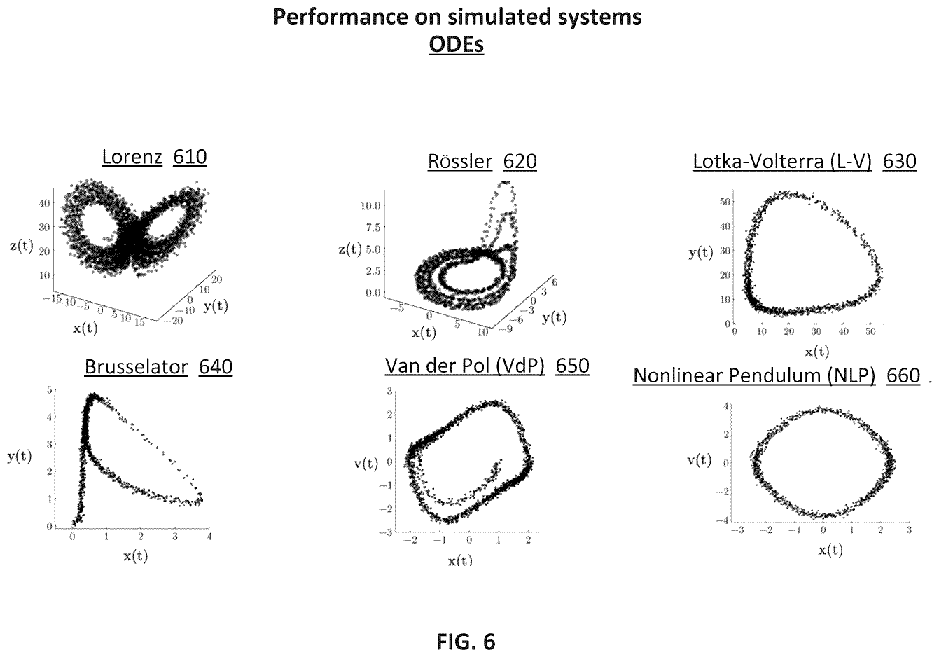

At least one example embodiment disclosed herein facilitates automated discovery of and interpretable model describing characteristics of a physical system. For example, various example embodiments may be employed to discover rules that govern how a system evolves over time, commonly referred to as system identification. Referring to FIG. 6, for example, various physical systems having true models corresponding to ordinary differential equations (ODEs) are illustrated. Graph 610 illustrates outputs of a Lorenz system. Graph 620 illustrates output of a Rössler attractor. Graph 630 illustrates output of a Lotka-Volterra (L-V) competition model. Graph 640 illustrates output of a Brusselator autocatalytic reaction model. Graph 650 illustrates output of a Van der Pol (VdP) oscillator. Graph 660 illustrates output of a Nonlinear Pendulum (NLP).

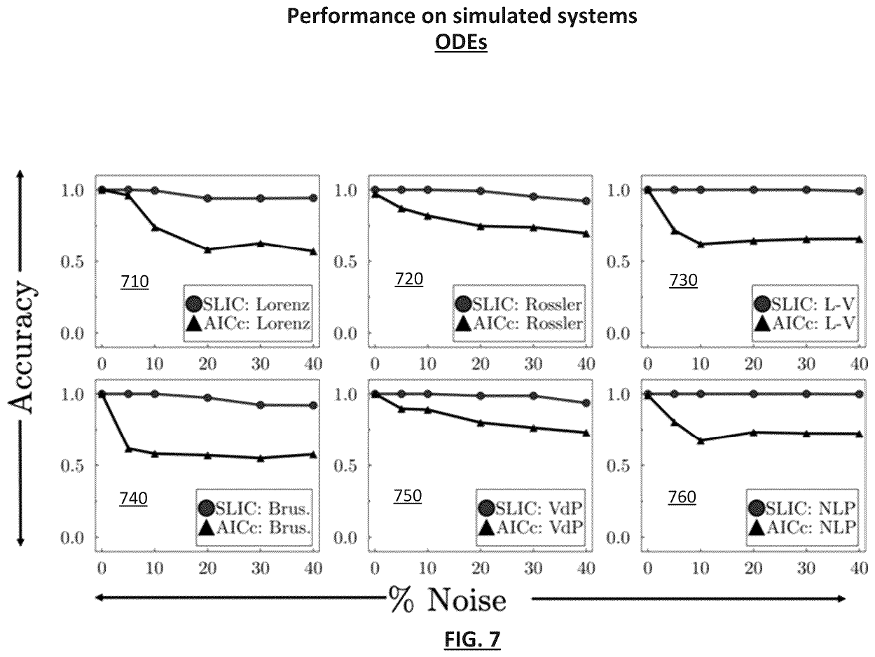

Referring now to both FIG. 7 and FIG. 6, graphs 710, 720, 730, 740, 750, and 760 provide accuracy comparisons of models of various physical systems discovered using SLIC techniques according to various example embodiments, and models discovered using conventional AICc. For example, graph 710 demonstrates that the accuracy a Lorenz system model obtained using AICc techniques decreases from an accuracy close to 100% when the data does not include noise, to an accuracy of about 50% when the noise content reaches 40%. By contrast, a Lorenz system model selected using one or more SLIC techniques according to various example embodiments remains relatively close to 100% accuracy over the same range of noise conditions. Graph 720 demonstrates that the accuracy a Rossler system model obtained using AICc techniques generally decreases as the amount of noise increases, while a Rossler model selected using one or more SLIC techniques according to various example embodiments remains relatively constant. Similar results with respect to Lotka-Voltera, Brusselator, Van der Pol, and nonlinear pendulum systems are illustrated by graphs 730, 740, 750, and 760.

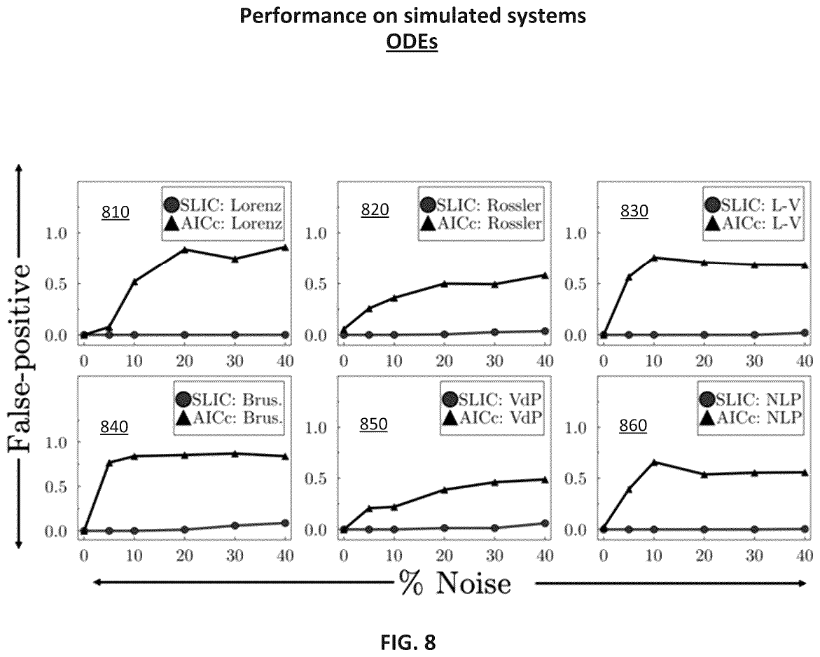

Referring next to both FIG. 8 and FIG. 6, graphs 810, 820, 830, 840, 850, and 860 comparisons of false-positive results generated by models of various physical systems discovered using SLIC techniques according to various example embodiments, and models discovered using conventional AICc. Graphs 810, 820, 830, 840, 850, and 860 illustrate that the number of false positives produced by Lorenz, Rossler, Lotka-Voltera, Brusselator, Van der Pol, and Nonlinear Pendulum system models obtained using AICc techniques increase as the noise content of the data increases. By contrast, models of each system type obtained using SLIC techniques according to various example embodiments remains relatively unchanged, and close to zero, over the same range of noise conditions that cause the AICc chosen models to produce more false positives. It may be noted that for some types of physical systems, the number of false positives increases rapidly between 0% and 10% noise, then levels off, while AICc selected models of other types of physical systems increase more gradually as noise increases. In each case, however, the false-positive performance of models selected using various SLIC techniques presented herein is superior to those of AICc selected models.

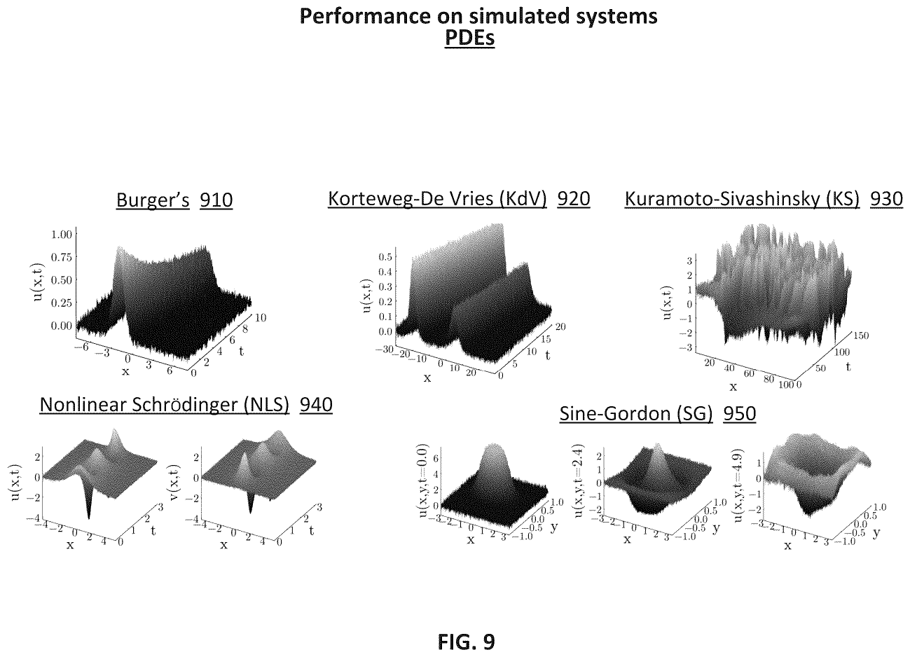

Referring next to FIG. 9, various physical systems having true models corresponding to partial differential equations (ODEs) are illustrated in accordance with various example embodiments. Graph 910 illustrates outputs of a dynamic fluid system governed by Burger's equation. Graph 920 illustrates output of a shallow water surface wave system governed by a Korteweg-De Vries equation. Graph 930 illustrates output of a chaotic system, such as flame front instability, fluid film flow, or wave dynamics, governed by a Kuramoto-Sivashinsky equation. Graph 940 illustrates an output describing probability waves of a small-particle system as described by a nonlinear Schrödinger equation. Graph 950 illustrates output of a system described by a Sine-Gordon function.

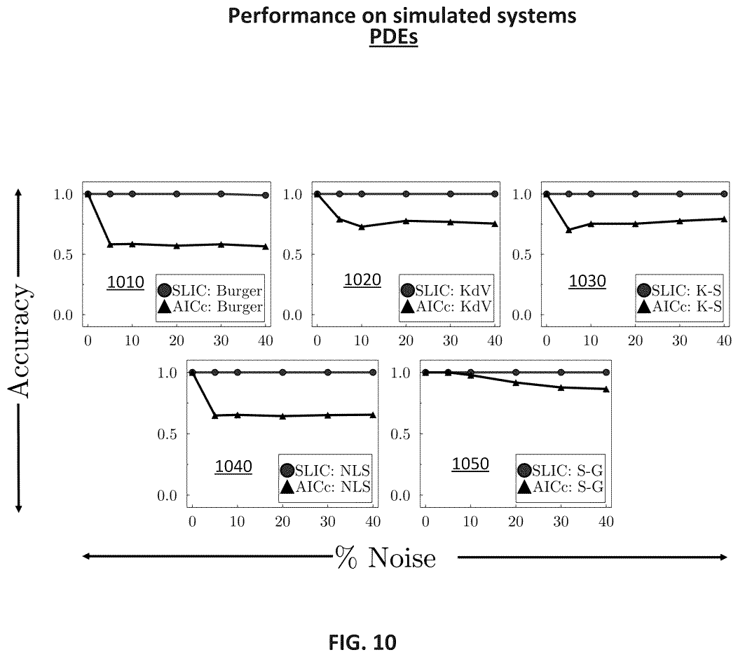

Referring now to both FIG. 10 and FIG. 9, graphs 1010, 1020, 1030, 1040, and 1050, provide accuracy comparisons of models of various physical systems discovered using SLIC techniques according to various example embodiments, and models discovered using conventional AICc. For example, graph 1010 demonstrates that the accuracy of a Burger's system model obtained using AICc techniques decreases from an accuracy close to 100% when the data does not include noise, to an accuracy of about 50% when more than about 5% noise is present in the data. By contrast, a Burger's system model selected using one or more SLIC techniques according to various example embodiments remains relatively close to 100% accuracy when the data includes up to 40% noise.

Graph 1020 demonstrates that the accuracy of a Korteweg-De Vries system model obtained using AICc techniques is reduced by about 20% or more when the data includes more than about 5% noise. By contrast, a Korteweg-De Vries system model determined using one or more SLIC techniques according to various example embodiments remains relatively constant at close to 100%, even with noisy data. Similar results are obtained with respect to models of Kuramoto-Sivashinsky, nonlinear Schrödinger, and Sine-Gordon functions, as illustrated by graphs 1030, 1040, and 1050.

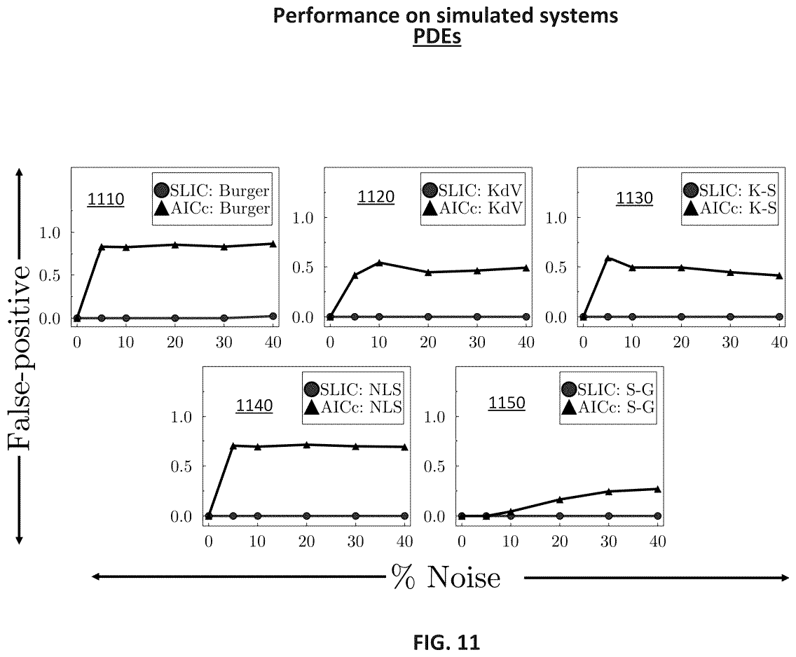

Referring next to both FIG. 11 and FIG. 9, graphs 1110, 1020, 1130, 1140, 1150, and 1160 comparisons of false-positive results generated by models of various physical systems discovered using SLIC techniques according to various example embodiments, and models discovered using conventional AICc. Graphs 1110, 1120, 1130, 1140, and 1150 illustrate that the number of false positives produced by models Korteweg-De Vries, Kuramoto-Sivashinsky, nonlinear Schrödinger, and Sine-Gordon systems obtained using AICc techniques increase as the noise content of the data increases. By contrast, false positive results produced by models of those same system types obtained using SLIC techniques according to various example embodiments, maintain a false positive rate relatively unchanged, and close to zero, over the same range of noise conditions.

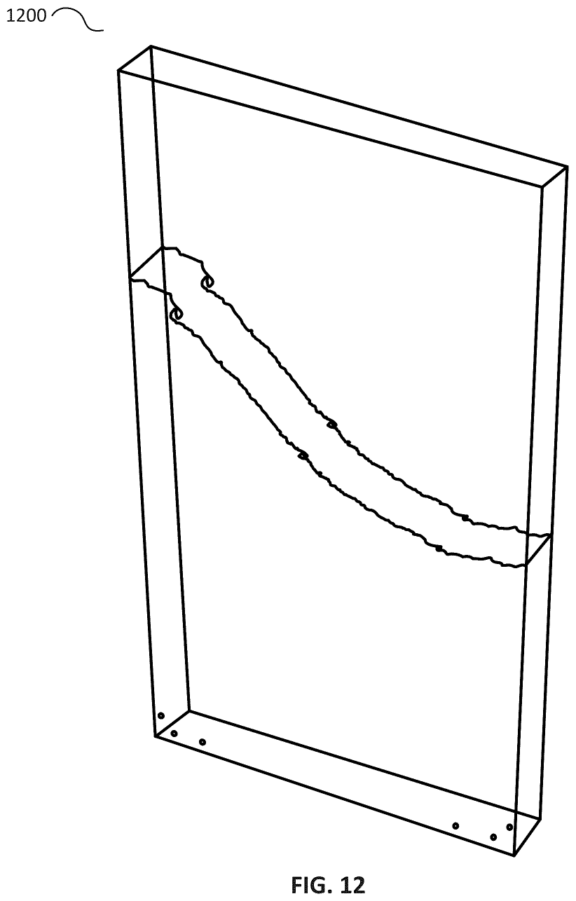

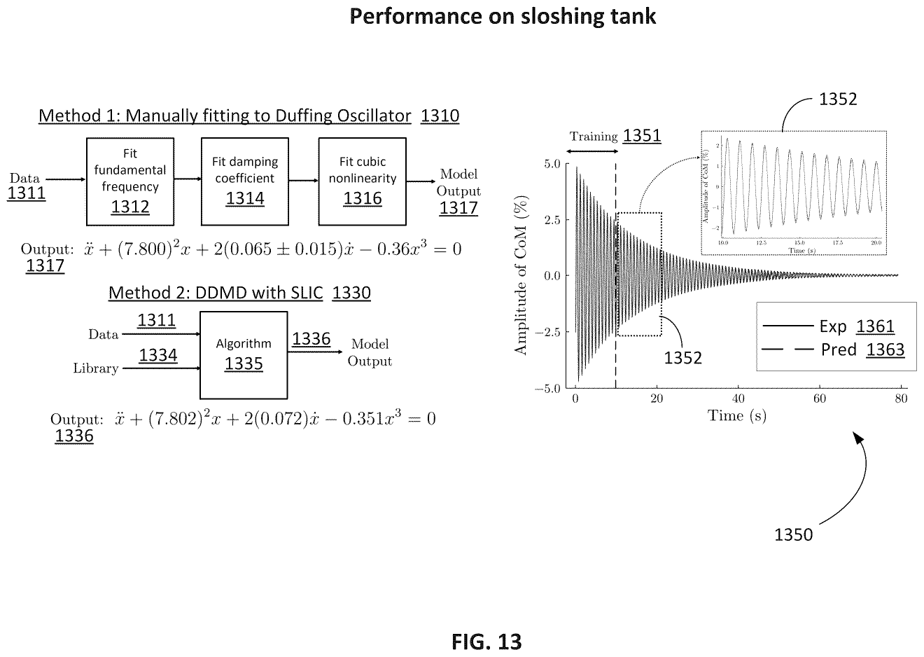

Referring next to FIGS. 12-14, discovery of a model describing behavior of a slosh tank will be discussed in accordance with various example embodiments. FIG. 12 is a diagram of fluid in a sloshing tank. Note that the center of mass dynamics of the fluid in the sloshing tank may be modeled as a Duffing Oscillator. FIG. 13 illustrates both a manual method 1310 of fitting Duffing Oscillator, and an automated model discovery technique 1330 in accordance with various example embodiments disclosed herein.

As illustrated by manual method 1310, to manually fit a Duffing Oscillator data 1311 the fundamental frequency of the system is determined at block 1312. As shown by block 1314, a damping coefficient of the system is determined, followed by a determination of a cubic nonlinearity, as shown by block 1316. The output 1317 includes the individually determined fundamental frequency, damping coefficient, and cubic nonlinearity.

In at least one example embodiment, a model 1336 of the Duffing Oscillator is determined, without separately fitting the fundamental frequency, damping coefficient, and cubic nonlinearity. In particular, the oscillator data 1311 and a library of model terms may be input into a device configured to execute a sparsifying algorithm 1335 according to various example embodiments, and the model 1336, which describes the system response, is output without individually and sequentially determining the fundamental frequency, damping coefficient, and cubic nonlinearity.

Also illustrated by FIG. 13 is a graph 1350 illustrating a plot of the amplitude of the center of mass (COM) of the sloshing liquid vs. time. In graph 1350, the solid line represents experimentally obtained data 13651, and the dashed line represents predicted data 1363, as predicted by the model 1336. Note that the experimentally obtained data 13651 and the predicted data 1363 so closely overlap that it is difficult to visually distinguish the two lines. Even in graph 1352, an enlarged view of graph 1350 between 10 and 20 seconds, the experimentally obtained data 13651 and the predicted data 1363 substantially overlap.

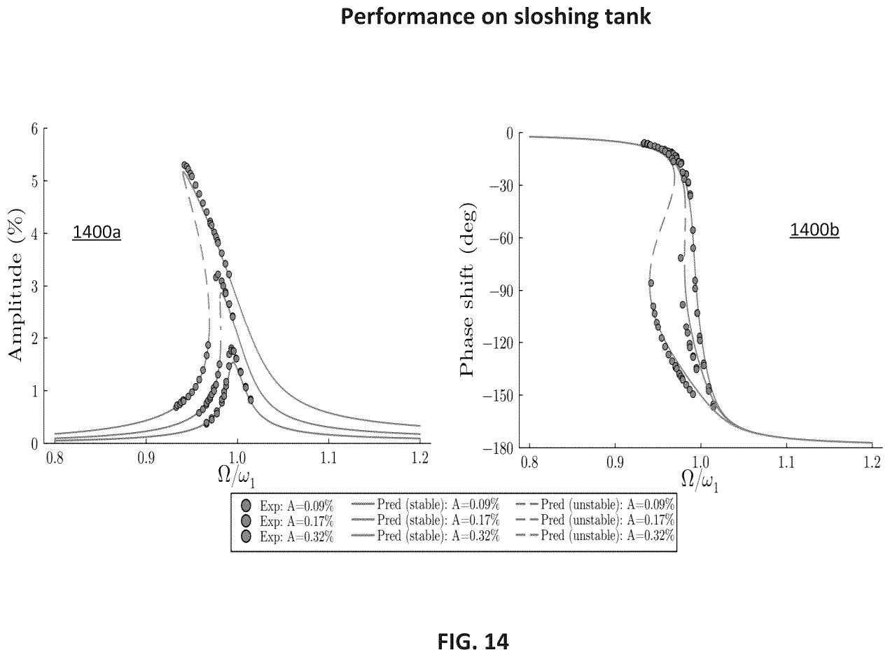

Referring next to FIG. 14 amplitude and phase shift performance of the model 1336 of the slosh tank (FIG. 12) discovered using the sparsifying algorithm 1335 according to one or more example embodiments with be discussed. The graphs included in FIG. 14 demonstrate that a model of a system discovered from unforced data using the sparsifying algorithm 1335 may be used to predict steady-state forcing behavior of the same system. The term “unforced data” in this example embodiment refers to state data obtained by shaking the sloshing tank, then letting the liquid in the sloshing tank settle to equilibrium. The “steady state forcing behavior” refers to behavior of the system when the tank is continually sloshed back and forth with some amplitude and frequency. The markers represent experimental data, and solid/dashed lines represent predictions generated using the discovered model.

For example, graph 1400a illustrates that a model discovered using various example embodiments disclosed herein accurately predicts the steady-state amplitude of the sloshing tank when the sloshing tank is being forced/driven. The y-axis of graph 1400a is the steady state amplitude of the tank's center of mass as a percent of the tank width. The x-axis is the forcing frequency (the frequency at which the tank is being sloshed) divided by the natural frequency (the frequency of oscillation when there is no forcing). The different plots in graph 1400a represent forcing with different strengths or amplitudes (how strongly the tank is being shaken, expressed as a percent of the tank width). Graph 1400b shows the phase shift of the center of mass of the liquid in the sloshing tank that results from the forcing.

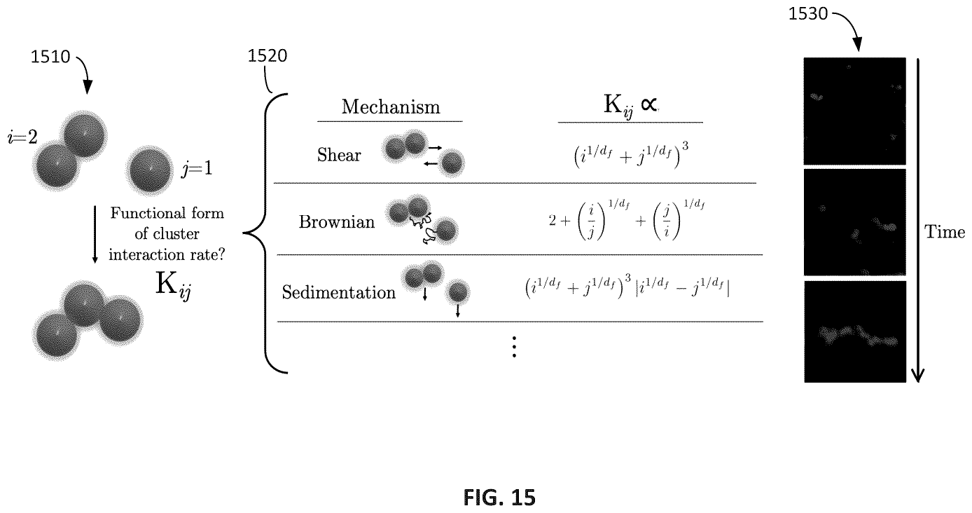

Referring next to FIGS. 15-17, discovery of a cluster formation model will be discussed in accordance with various example embodiments. Some example embodiments may be used to facilitate Pharmacokinetic-Pharmacodynamic (PK-PD) modeling, which is used in modern computationally driven drug discovery. In the PK-PD modeling approach, hand-crafted models and extensive parameter fitting routines may be used to understand and predict the temporal evolution and impact of drugs on the body. Although powerful for its interpretability, the PK-PD modeling approach is often costly and subject to parameter tuning, which may limit the generality of the model. With our increasing ability to collect data, various example embodiments described herein may facilitate automated model building without parameter tuning, thus providing an inexpensive alternative to current PK-PD methodologies. More specifically, some example embodiments may be used to discover functional form of cluster-cluster interaction rates (the kernel) and prediction of cluster growth rates in cases where initial conditions are unseen.

In FIG. 15, diagram 1510 illustrates the cluster-cluster interaction rate (i.e. the kernel, Kᵢⱼ) for clusters of different particle number. The indices i, j denote the number of monomers/particles per cluster. Diagram 1520 shows functional forms of kernels for different physical processes/mechanisms and a corresponding equation. Note that each mechanism depends on an unknown parameter, d_{f}. Diagram 1530 shows a fluorescent timeseries images of a ribonucleic acid (RNA)-liposome system. The scale bar used is 1 μm.

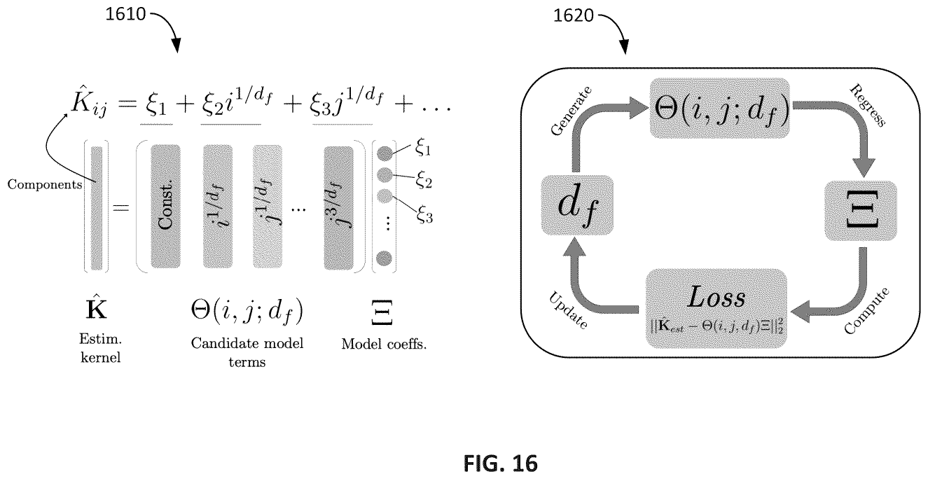

In FIG. 16, diagram 1610 illustrates a regression problem with relevant kernels, in accordance with various example embodiments. At least one example embodiment extracts the coefficients, Ξ, given a vector of kernel values, \hat{K}ₑₛₜ, which is estimated from image data, and library of kernel components, Θ(i, j; d_{f}), which depends on i, j (the numbers of particles in the interacting clusters) and is parameterized by an unknown parameter, d_{f}. The components of the kernel vector are denoted by Kᵢⱼ. Diagram 1620 illustrates a procedure that simultaneously/concurrently determines the unknown parameter, d_{f}, and the coefficients, Ξ, that determine the functional form of the kernel.

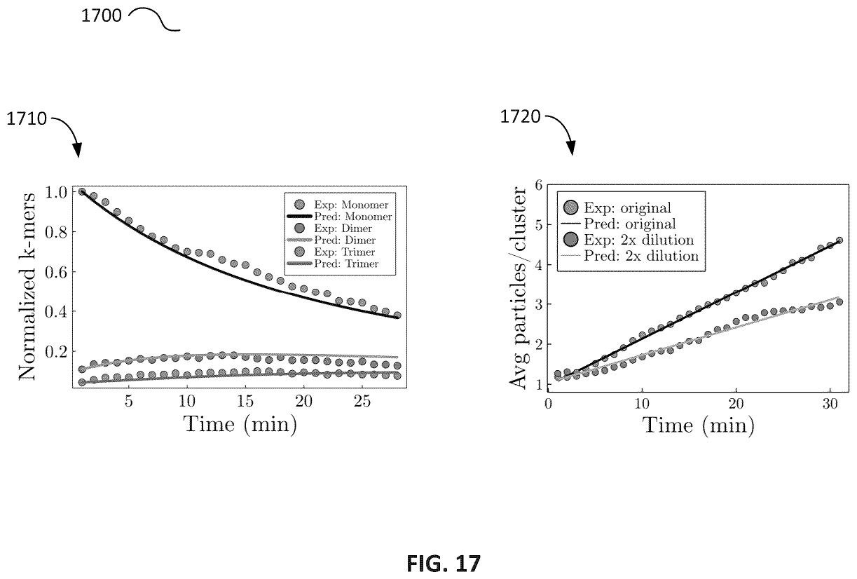

FIG. 17 includes graphs 1710 and 1720. As illustrated by graph 1710, the constant kernel returned by a SLIC technique in accordance with example embodiments, accurately describes the temporal evolution of k-mers (clusters consisting of ‘k’ monomers). K-mers up to trimers are shown for clarity. Graph 1720 illustrates the constant kernel determined by SLIC accurately predicts the growth rate of 2× diluted solution of RNA-liposomes.

One or more example embodiments facilitate data-driven control of systems, in which system identification is a first step. Some example embodiments may be useful in augmenting and/or improving the reinforcement learning process, which is frequently used to allow autonomous agents, such as robots, to perform required tasks. Consider that, especially where the space of action of an autonomous agent is large, it may be difficult for the autonomous agent which may be parameterized by neural networks, to learn correct actions based solely on reinforcement learning. Furthermore, reinforcement learning may be expensive, time-consuming, and lacks interpretability. Various example embodiments presented herein, however, provide an interpretable, limited action space for agents that may be faster and more cost-efficient to learn.

Other example embodiments may be useful in performing dynamic diagnostics. Dynamic diagnostics are processes performed by electronic systems, for example heart monitors and power grids, which dynamically interface with the physical world are ubiquitous, However, due to system complexity, debugging failure modes of these systems is often challenging. Various example embodiments facilitate an automated, data-driven approach to assess and understand the anomalous dynamics leading to failures of these systems by uncovering the dynamics.

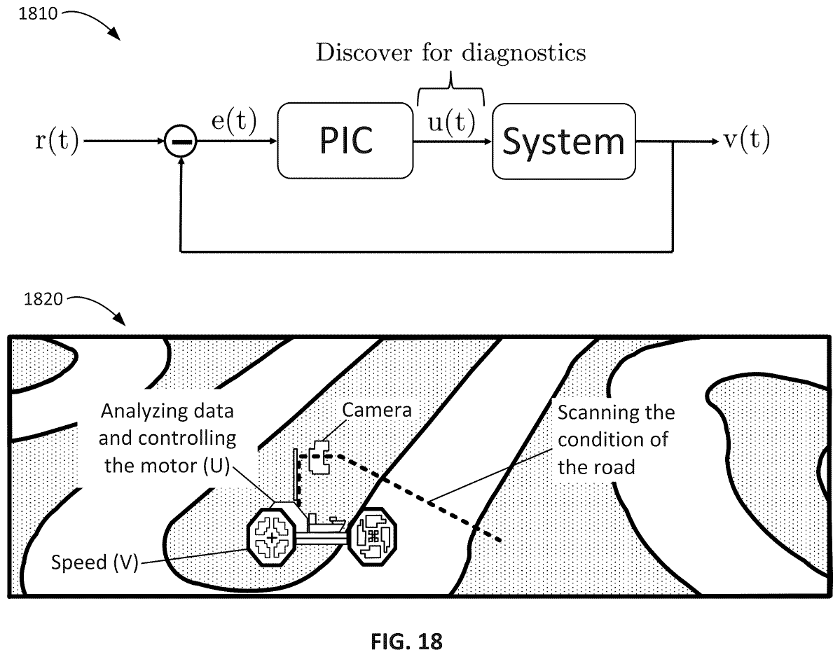

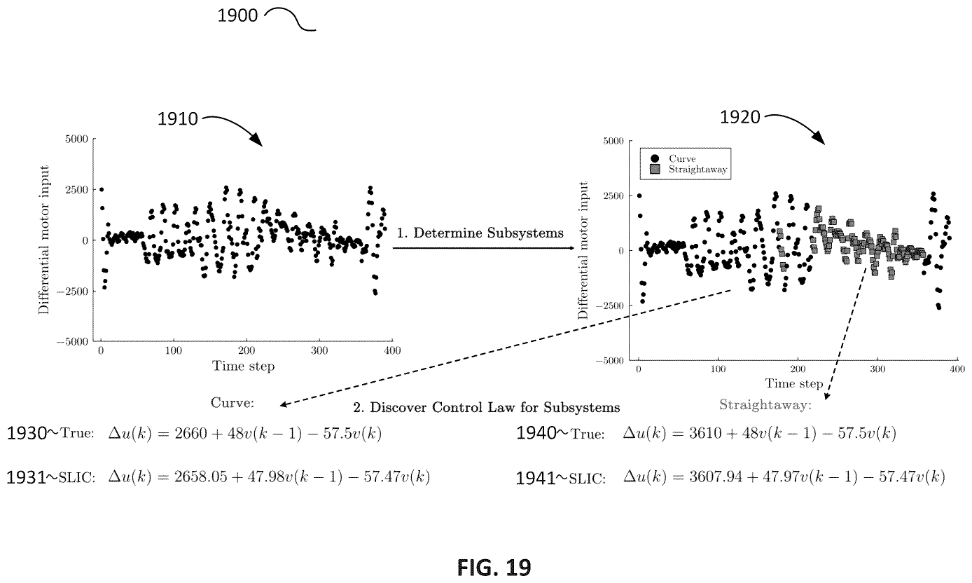

Referring next to FIGS. 18 and 19, model discovery in physical system diagnostics will be discussed in accordance with various example embodiments. In at least one example embodiment, a SLIC technique disclosed herein accurately recovers subsystem control laws of an autonomous vehicle for dynamic diagnostics. Schematic diagram 1810 illustrates a closed-loop proportional integral control (PIC) scheme associated with an autonomous vehicle. At least one example embodiment may be used to determine the functional form of the control law u(t) for diagnostics. Diagram 1820 illustrates an autonomous vehicle as that scans an upcoming road for straightaway or curve conditions, which dictates which control law will be used, e.g. a “straightaway” law or a “curve” law. FIG. 19 includes graphs illustrates dynamic subsystems, i.e. road conditions, which may indicate an upcoming curve or straightaway. Graph 1910 plots differential motor inputs at particular times. As illustrated by graph 1920, a SLIC model detection process in accordance with various example embodiments may be used to automatically and correctly determine the functional form of the control law for each dynamic subsystem (e.g. a curve or a straightaway). In the illustrated example embodiment, the true control law for a curve, u(t_{tc}), is shown by equation 1930, and the discovered control law for a curve, u(t_{dc}), is shown by equation 1931. Similarly, the true control law for a straightaway, u(tₜₛ), is shown by equation 1940, and the discovered control law for a straightaway, u(t_{ds}), is shown by equation 1941.

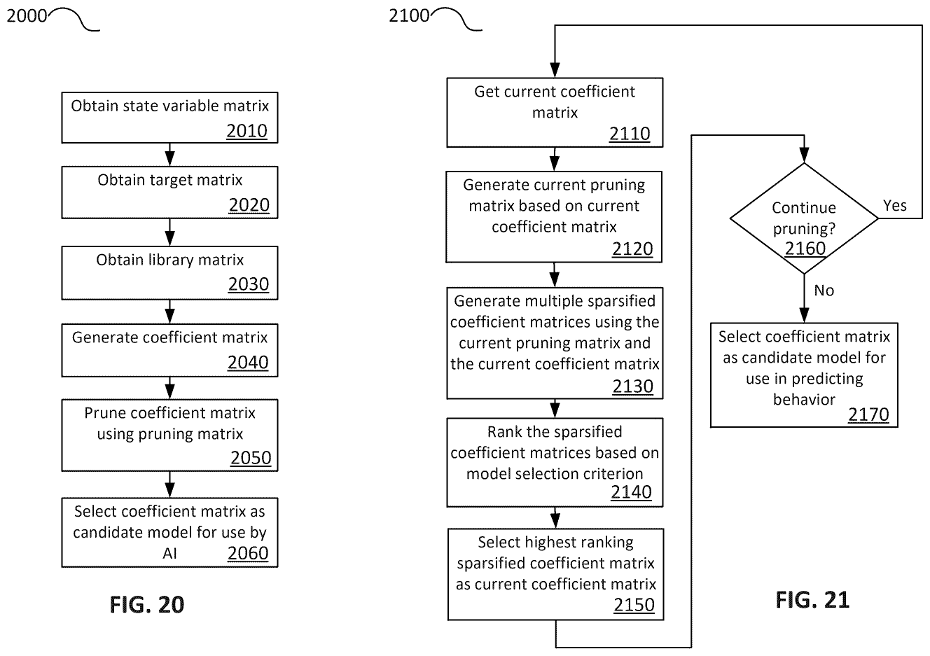

Referring next to FIG. 20, a method 2000 of training an artificial intelligence model to predict, analyze, and/or model behavior of a physical system will be discussed in accordance with various example embodiments.

As illustrated by block 2010, a state variable matrix, as discussed previously with reference to FIG. 2, may be obtained. The state variable matrix may, but need not, include actually measured state variables of a system with respect to time, frequency, amplitude, displacement, phase shift or the like. In some example embodiments, obtaining the state variable matrix may include recording empirical data. In one or more example embodiments, the state variable matrix includes state variables representing the recorded empirical data. The state variables may include a noise component.

As illustrated by block 2020, a target matrix is obtained, as previously discussed with reference to FIG. 2. In some systems, the target matrix is obtained directly via measurement. This is the case for the autonomous vehicle example discussed previously with reference to FIGS. 18-19.

For dynamical systems, for example when it is the target matrix is the derivative of the state variables, the target matrix may be estimated from observed state variable data.

As illustrated by block 2030, a library matrix is obtained. The library matrix includes user-supplied candidate model terms. These user-supplied candidate model terms may be used in some example The number of rows in the library matrix may be determined based on a number of data points to be considered. An example of a library matrix populated with values is shown in FIG. 4.

As illustrated by block 2040, a coefficient matrix is generated based on the library matrix and the estimated derivative (target) matrix. In at least one example embodiment, the coefficient matrix is determined by multiplying the pseudoinverse of the library matrix by the target matrix, as discussed above with respect to FIG. 3.

As illustrated by block 2050, the coefficient matrix is pruned to generate multiple sparsified coefficient matrices. The pruning process, according to at least one example embodiment, includes removing (or setting to zero) any terms in the coefficient matrix that satisfy (or conversely do not satisfy) a corresponding pruning threshold. Satisfying (or not satisfying) a pruning threshold may include being less than a pruning threshold, being equal to a pruning threshold, being less than or equal to a pruning threshold, being within a given range of the pruning threshold, or the like. In at least one example embodiment, an element is removed from the coefficient matrix in response to the value of that element being less than the pruning threshold. The pruning process used to generate the sparsified coefficient matrices is discussed in greater detail with respect to FIG. 21.

As illustrated by block 2060, one of the multiple sparsified coefficient matrices is selected as a candidate model. In some example embodiments, selecting a sparsified coefficient matrix as a candidate model includes selecting, using an information-based model-selection criterion, the sparsified matrix that optimally describes the dynamic behavior of the physical system. In various example embodiments, the selected model may be used by an artificial intelligence application to predict, model, and/or analyze behavior of a physical system. Various examples of using the selected model to predict, model, and/or analyze behavior of a physical system have been discussed above.

Referring next to FIG. 21, a method 2100 of pruning a coefficient matrix to identify a sparsified coefficient matrix as a candidate for use in predicting, modeling, and/or analyzing behavior of a physical system will be discussed in accordance with various example embodiments.

As illustrated by block 2110, a current coefficient matrix is obtained. The current coefficient matrix may be, for example, a non-sparse coefficient matrix generated by multiplying a pseudoinverse of a library matrix with a target matrix, or a sparsified coefficient matrix generated during a previous iteration of method 2100.

As illustrated by block 2120, a pruning matrix is generated. The pruning matrix includes elements representing pruning thresholds that may be used to determine which elements of the current coefficient matrix are to be removed from a sparsified coefficient matrix. In at least one example embodiment, the elements of the pruning matrix are generated dynamically during the model determination process, and may vary for each iteration of the process. In some such example embodiments, the pruning matrix may be generated by determining a maximum absolute value of the estimated model coefficients included in the current coefficient matrix, determining a minimum absolute value of the estimated model coefficients included in the current coefficient matrix, and generating the pruning matrix of coefficient pruning thresholds based on the maximum absolute value of the estimated model coefficients and the minimum absolute value of the estimated model coefficients. For example, if the maximum absolute value of the coefficients in a first column of the current coefficient matrix is 4, and the minimum absolute value of those same coefficients is 2, then a series of pruning coefficients for the first column may be set. The pruning coefficients may have values between, and potentially including, 4 and 2.

In some example embodiments, the number of pruning coefficients between the maximum absolute value and the minimum absolute value may be established by a hyperparameter selected in advance based on efficiency targets, processing power, or the like. The pruning coefficients may, but need not be, evenly distributed between the maximum absolute value and the minimum absolute value. Other example embodiments may use pruning thresholds determined using other suitable techniques.

As illustrated by block 2130, multiple sparsified coefficient matrices are generated by pruning the current coefficient matrix using the pruning thresholds included in the pruning matrix. In at least one example embodiment, a sparsified coefficient matrix may be generated for each combination of pruning thresholds included in the pruning matrix. In some example embodiments, pruning the current coefficient matrix to generate a sparsified coefficient matrix includes removing any coefficient in the current coefficient matrix that is less than the corresponding pruning threshold.

As illustrated by block 2140, the multiple sparsified coefficient matrices are ranked in accordance with the model-selection criterion discussed above with reference to FIG. 5. As illustrated by block 2150, the highest ranking sparsified coefficient matrix is selected as the current coefficient matrix.

As illustrated by block 2160, a check is made to determine whether additional pruning iterations are to be performed. In some example embodiments, pruning may be performed until a sparsity target is reached. In some such example embodiments, the sparsity target may be set using a hyperparameter. In other example embodiments, a hyperparameter may be used to establish a fixed number of pruning iterations. In yet other example embodiments, the number of pruning iterations may depend on a number of terms in the library matrix. In still further example embodiments, pruning may be considered to be complete when a score threshold is reached, when no coefficients are removed during a pruning iteration, or based on some other suitable metric. If additional pruning iterations are to be performed method 2100 returns to block 2110, otherwise method 2100 continues to block 2170.

As illustrated by block 2170, if no additional pruning iterations are to be performed, the current coefficient matrix is selected as the candidate model for use in predicting, modeling, and/or analyzing, behavior of a physical system.

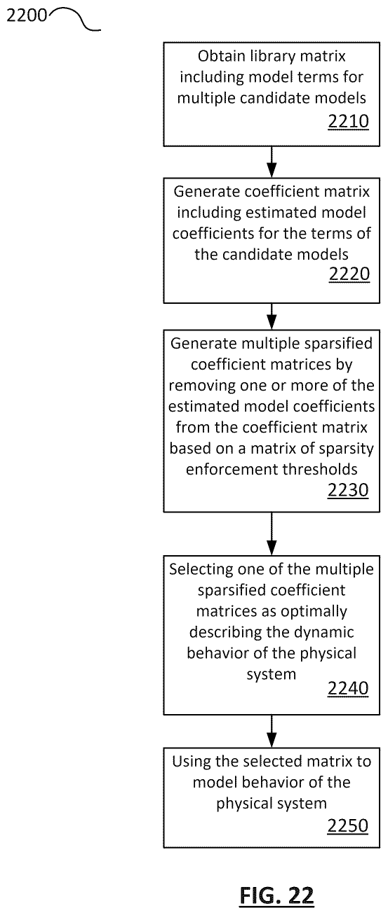

Referring next to FIG. 22, a method 2200 of modeling behavior of a physical system will be discussed in accordance with various example embodiments.

As illustrated by block 2210, a library matrix including model terms for multiple candidate models is obtained from user input. As illustrated by block 2220, a coefficient matrix including estimated model coefficient for the terms of the candidate modes is generated. As illustrated by block 2230, multiple sparsified coefficient matrices are generated by removing one or more of the estimated model coefficients from the coefficient matrix based on a matrix of sparsity enforcement thresholds. In at least one example embodiment, the sparsity enforcement thresholds correspond to the pruning thresholds previously discussed.

As illustrated by block 2240, one of the multiple sparsified coefficient matrices is selected as optimally describing the dynamic behavior of the physical system. In at least one example embodiment, the optimal sparsified coefficient matrix is determined by the following model-selection criterion: SLIC(n, k)=n log(\hat{∈})+n log(k)=n log(k\hat{∈}).

As illustrated by block 2250, the sparsified coefficient matrix selected as optimal at block 2240 is used model behavior of a physical system.

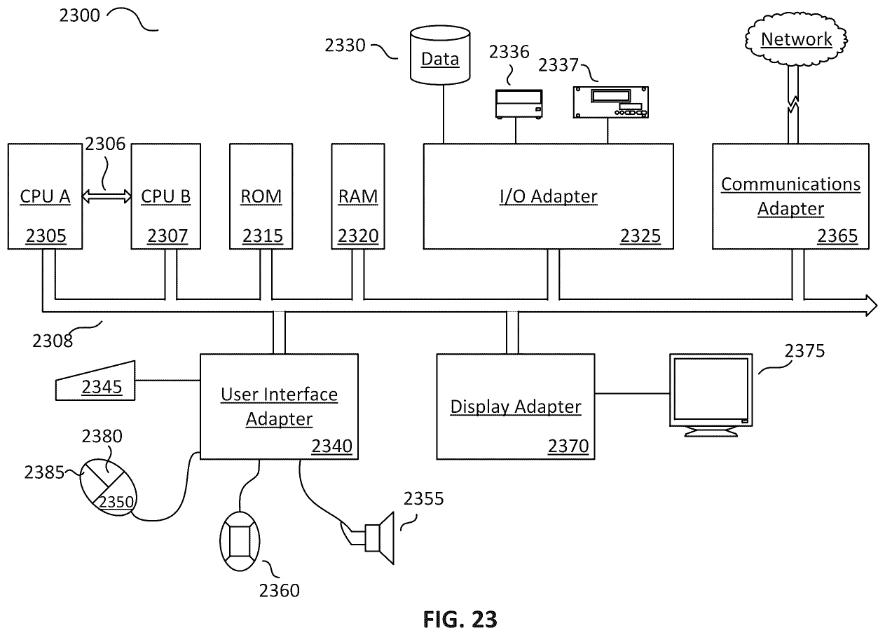

Referring now to FIG. 23, a high-level block diagram of a processing system 2300 is illustrated and discussed. Methods and processes and other embodiments discussed previously may be implemented in a processing system executing a set of instructions stored in memory, or on a removable computer readable medium. An example of a processing system according to some embodiments is illustrated in FIG. 17. Processing system 2300 includes one or more central processing units, such as CPU A 2305 and CPU B 2307, which may be conventional microprocessors interconnected with various other units via at least one system bus 2308. CPU A 2305 and CPU B 2307 may be separate cores of an individual, multi-core processor, or individual processors connected via a specialized bus 2306. In some embodiments, CPU A 2305 or CPU B 2307 may be a specialized processor, such as a graphics processor, other co-processor, or the like.

Processing system 2300 includes random access memory (RAM) 2320; read-only memory (ROM) 2315, wherein the ROM 2315 could also be erasable programmable read-only memory (EPROM) or electrically erasable programmable read-only memory (EEPROM); and input/output (I/O) adapter 2325, for connecting peripheral devices such as disk units 2330, optical drive 2336, or tape drive 2337 to system bus 2308; a user interface adapter 2340 for connecting keyboard 2345, mouse 2350, speaker 2355, microphone 2360, or other user interface devices to system bus 2308; communications adapter 2365 for connecting processing system 2300 to an information network such as the Internet or any of various local area networks, wide area networks, telephone networks, or the like; and display adapter 2370 for connecting system bus 2308 to a display device such as monitor 2375. Mouse 2350 has a series of buttons 2380, 2385 and may be used to control a cursor shown on monitor 2375.

Various example embodiments discussed above provide model selection techniques that enforce sparsity and mitigate the impact of noise on algorithm performance, thereby mitigating the possibility of erroneously identifying system dynamics with spurious model terms. Some such embodiments use both model ensembling and Galerkin-projection. Moreover, one or more example embodiments provide a technique of performing system identification that is inherently robust to data quantity, and capable of recovering the dynamics of systems, ranging from low-data ordinary differential equations to high-data partial differential equations.

One or more example embodiments employ computationally efficient regression techniques. For example, some embodiments disclosed herein are capable of recovering the true model governing system dynamics using a single trajectory of that dynamic system, thereby promoting data efficiency.

Another benefit of one or more example embodiments disclosed herein is interpretability. In various example embodiments, a library of candidate model functions relates system inputs (e.g., state variable observations) to system outputs (e.g., derivatives) to return an interpretable model of the system. This may serve as a starting point for further inquiry and analysis, such as bifurcation and sensitivity analysis, etc.

One or more example embodiments disclosed herein may also be integrated with dimensionality-reduction method, for example, with high-dimensional data whose essential dynamics evolve on a low-dimensional manifold as seen frequently in fluid dynamics, network dynamics, etc. Dimensionality-reduction methods may include, but are not limited to, principal component analysis (PCA) and encoder-decoder neural network architectures, and may be used to perform one-shot latent space model discovery. In some such example embodiments, a dimensionality-reduction method may be used to obtain a descriptive set of latent space coordinates, and various techniques disclosed herein may be used to uncover the dynamics in this latent space. Such an embodiment may not only facilitate user understanding of a systems being probed, but may also greatly reduce computational resources dedicated to simulating these systems.

One or more example embodiments may also be integrated with other system identification methods, for example methods that seek to discover models directly from data, including symbolic regression and neural networks.

Some example embodiments use hyperparameters, in addition to the automatically discovered sparsity hyperparameters, to tune the degree to which sparsity is enforced, thereby mitigating the possibility of underfitting. For example, in some example embodiments, a “density” hyperparameter may be used to establish how many values between the maximum absolute value and the minimum absolute value of the estimated model coefficients are considered during generation the pruning matrix.

In example embodiments discussed herein, a user provides a “library” of candidate nonlinear functions to be considered as potentially modeling a physical system. However, even if the ‘correct’ model nonlinearities are not included in the library, a model sufficiently close to the ‘true’ model may still be recovered. Furthermore, a model selection methodology according to example embodiments may be combined with neural-network-based approaches. In some example embodiments, various implicit kernel methods may also be used to improve computational efficiency.

As discussed herein, the terminology “one or more” and “at least one” may be used interchangeably. Furthermore, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it may be directly connected or coupled to the other element, or more intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the preceding description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures, and techniques may be shown without unnecessary detail in order to avoid obscuring example embodiments.

As discussed herein, illustrative embodiments have been described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment or other network elements and/or hardware. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently, or simultaneously. In addition, the order of the operations may be re-arranged. A process may be terminated when its operations are completed, but may also have additional steps not included in the Figure A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing and/or containing, instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory, and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, other network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUS, one or more microprocessors, one or more ASICs, or any other device or devices capable of responding to and executing instructions in a defined manner.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Some Example Embodiments of the inventive concepts are as follows below:

Example Embodiment 1: A method of training an artificial intelligence model, the method comprising:
obtaining a target matrix;
obtaining a library matrix including a library of candidate model terms associated with a plurality of candidate models;
generating, based on the target matrix and the library matrix, a coefficient matrix including estimated model coefficients;
pruning the coefficient matrix based on a pruning matrix of coefficient pruning thresholds to generate at least one sparsified coefficient matrix; and
selecting one or more of the at least one sparsified coefficient matrix as a candidate to be used by the artificial intelligence model in predicting behavior of a physical system.

Example Embodiment 2: The method of Example Embodiment 1, further comprising:
selecting the one or more of the at least one sparsified coefficient matrix based on a model-selection criterion that scales with a number of data points.

Example Embodiment 3: The method of Example Embodiment 2, further comprising:
selecting a particular sparsified coefficient matrix as optimal based on the model-selection criterion.

Example Embodiment 4: The method of Example Embodiment 2, wherein selecting the one or more of the at least one sparsified coefficient matrix includes ranking a plurality of sparsified coefficient matrices based on the model-selection criterion.

Example Embodiment 5: The method of Example Embodiment 2, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.

Example Embodiment 6: The method of Example Embodiment 1, further comprising:
generating the coefficient matrix based on an equation of the form Ξ=Θ⁻¹Y, where Ξ is the coefficient matrix including the estimated model coefficients, Θ⁻¹ is a pseudoinverse of the library matrix including the library of candidate model terms, and Y is the target matrix.

Example Embodiment 7: The method of Example Embodiment 1, further comprising:
generating the target matrix by obtaining derivatives of a state variable matrix by numerically estimating the derivatives based on the state variables.

Example Embodiment 8: The method of Example Embodiment 1, wherein pruning the coefficient matrix includes:
removing one or more estimated model coefficients from the coefficient matrix in response to the one or more estimated model coefficients failing to satisfy an adaptively generated coefficient pruning threshold.

Example Embodiment 9: The method of Example Embodiment 8, further comprising:
determining a maximum absolute value of the estimated model coefficients included in the coefficient matrix;
determining a minimum absolute value of the estimated model coefficients included in the coefficient matrix; and
generating the pruning matrix of coefficient pruning thresholds based on the maximum absolute value of the estimated model coefficients and the minimum absolute value of the estimated model coefficients.

Example Embodiment 10: The method of Example Embodiment 9, further comprising:
during a first pruning iteration
   generating a first pruning matrix based on the maximum absolute value of the estimated model coefficients included in the coefficient matrix and the minimum absolute value of the estimated model coefficients included in the coefficient matrix;
   generating a plurality of first sparsified coefficient matrices by applying each of the coefficient pruning thresholds included in a first pruning matrix to the estimated model coefficients of a first coefficient matrix;
   selecting a selected sparsified coefficient matrix of the plurality of first sparsified coefficient matrices; and
during a second pruning iteration
   generating a second pruning matrix based on the maximum value of the estimated model coefficients included in the selected sparsified coefficient matrix, the minimum value of the estimated model coefficients included in the selected sparsified coefficient matrix, and the density value;
   generating a plurality of second sparsified coefficient matrices by applying each of the coefficient pruning thresholds included in a second pruning matrix to the estimated model coefficients of a first coefficient matrix; and
   selecting a selected second sparsified coefficient matrix of the plurality of second sparsified coefficient matrices to be used by the artificial intelligence model in predicting behavior of the physical system.

Example Embodiment 11: A method comprising:
generating, from a library matrix including a library of candidate model terms associated with a plurality of candidate models, a coefficient matrix including estimated model coefficients describing dynamic behavior of a physical system;
generating a plurality of sparsified coefficient matrices by removing one or more of the estimated model coefficients based on a matrix of sparsity enforcement thresholds;
selecting, based on a model-selection criterion that scales with a number of data points, a particular sparsified coefficient matrix of the plurality of sparsified coefficient matrices as optimally describing the dynamic behavior of the physical system; and
using the particular sparsified coefficient matrix to model behavior of the physical system.

Example Embodiment 12: The method of Example Embodiment 11, wherein generating the coefficient matrix includes:
obtaining a state variable matrix including state variables associated with the physical system;
constructing a target matrix based on the state variables; and
obtaining the library of candidate model terms as user input.

Example Embodiment 13: The method of Example Embodiment 12, further comprising:
generating the coefficient matrix based on an equation of the form Ξ=Θ⁻¹Y, where Ξ is the coefficient matrix including the estimated model coefficients, Θ⁻¹ is a pseudoinverse of the library matrix including the library of candidate model terms, and Y is the target matrix.

Example Embodiment 14: The method of Example Embodiment 11, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.

Example Embodiment 15: The method of Example Embodiment 11, wherein generating the plurality of sparsified coefficient matrices includes:
generating the matrix of sparsity enforcement thresholds based on an absolute value of a maximum value of the estimated model coefficients, an absolute value of a minimum value of the estimated model coefficients, and a density value; and
generating a sparsified coefficient matrix based for each element in the matrix of sparsity enforcement thresholds, each sparsified coefficient matrix being generated by removing any estimated model coefficients having a value exceeding a value of a corresponding element in the matrix of sparsity enforcement thresholds.

Example Embodiment 16: A processing device comprising:
a memory storing a program of instructions;
a processor coupled to the memory, and configured to execute the program of instructions to
   obtain a target matrix;
   obtain a library matrix including a library of candidate model terms associated with a plurality of candidate models;
   generate, based on the target matrix and the library matrix, a coefficient matrix including estimated model coefficients;
   prune the coefficient matrix based on a pruning matrix of coefficient pruning thresholds to generate at least one sparsified coefficient matrix; and
   select one or more of the at least one sparsified coefficient matrix as a candidate to be used by an artificial intelligence model in predicting behavior of a physical system.

Example Embodiment 17: The processing device of Example Embodiment 16, wherein the processor is further configured to execute the program of instructions to:
select the one or more of the at least one sparsified coefficient matrix based on a model-selection criterion that scales with a number of data points.

Example Embodiment 18: The processing device of Example Embodiment 17, wherein the processor is further configured to execute the program of instructions to:
select a particular sparsified coefficient matrix as optimal based on the model-selection criterion.

Example Embodiment 19: The processing device of Example Embodiment 17, wherein the processor is further configured to execute the program of instructions to select the one or more of the at least one sparsified coefficient matrix by ranking a plurality of sparsified coefficient matrices based on the model-selection criterion.

Example Embodiment 20: The processing device of Example Embodiment 17, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.

Example Embodiment 21: The processing device of Example Embodiment 16, wherein the processor is further configured to execute the program of instructions to:
generate the coefficient matrix based on an equation of the form Ξ=Θ⁻¹Y, where Ξ is the coefficient matrix including the estimated model coefficients, Θ⁻¹ is a pseudoinverse of the library matrix including the library of candidate model terms, and Y is the target matrix.

Example Embodiment 22: The processing device of Example Embodiment 16, wherein the processor is further configured to execute the program of instructions to:
generated the target matrix by obtaining derivatives of the state variables by numerically estimating the derivatives based on the state variables.

Example Embodiment 23: The processing device of Example Embodiment 16, wherein the processor is further configured to execute the program of instructions to prune the coefficient matrix by:
removing one or more estimated model coefficients from the coefficient matrix in response to the one or more estimated model coefficients failing to satisfy an adaptively generated coefficient pruning threshold.

Example Embodiment 24: The processing device of Example Embodiment 23, wherein the processor is further configured to execute the program of instructions to:
determine an absolute value of a maximum value of the estimated model coefficients included in the coefficient matrix;
determine an absolute value of a minimum value of the estimated model coefficients included in the coefficient matrix;
obtain a density value; and
generate the pruning matrix of coefficient pruning thresholds based on the absolute value of maximum value of the estimated model coefficients, the absolute value of the minimum value of the estimated model coefficients, and the density value.

Example Embodiment 25: The processing device of Example Embodiment 24, wherein the processor is further configured to execute the program of instructions to prune the coefficient matrix by:
during a first pruning iteration
generate a first pruning matrix based on the maximum value of the estimated model coefficients included in the coefficient matrix, the minimum value of the estimated model coefficients included in the coefficient matrix, and the density value;
generate a plurality of first sparsified coefficient matrices by applying each of the coefficient pruning thresholds included in a first pruning matrix to the estimated model coefficients of a first coefficient matrix;
select a selected sparsified coefficient matrix of the plurality of first sparsified coefficient matrices; and
during a second pruning iteration
generate a second pruning matrix based on the maximum value of the estimated model coefficients included in the selected sparsified coefficient matrix, the minimum value of the estimated model coefficients included in the selected sparsified coefficient matrix, and the density value;
generate a plurality of second sparsified coefficient matrices by applying each of the coefficient pruning thresholds included in a second pruning matrix to the estimated model coefficients of a first coefficient matrix; and
use a selected second sparsified coefficient matrix of the plurality of second sparsified coefficient matrices to model behavior of the physical system.

What is claimed is:

1. A method of training an artificial intelligence model, the method comprising:
obtaining a target matrix;
obtaining a library matrix including a library of candidate model terms associated with a plurality of candidate models;
generating, based on the target matrix and the library matrix, a coefficient matrix including estimated model coefficients;
pruning the coefficient matrix based on a pruning matrix of coefficient pruning thresholds to generate at least one sparsified coefficient matrix; and
selecting one or more of the at least one sparsified coefficient matrix as a candidate to be used by the artificial intelligence model in predicting behavior of a physical system.

2. The method of claim 1, further comprising:
selecting the one or more of the at least one sparsified coefficient matrix based on a model-selection criterion that scales with a number of data points.

3. The method of claim 2, further comprising:
selecting a particular sparsified coefficient matrix as optimal based on the model-selection criterion.

4. The method of claim 2, wherein selecting the one or more of the at least one sparsified coefficient matrix includes ranking a plurality of sparsified coefficient matrices based on the model-selection criterion.

5. The method of claim 2, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.

6. The method of claim 1, further comprising:
generating the coefficient matrix based on an equation of a form Ξ=Θ⁻¹Y, where Ξ is the coefficient matrix including the estimated model coefficients, Θ⁻¹ is a pseudoinverse of the library matrix including the library of the candidate model terms, and Y is the target matrix.

7. The method of claim 1, further comprising:
generating the target matrix by obtaining derivatives of a state variable matrix by numerically estimating the derivatives based on state variables.

8. The method of claim 1, wherein pruning the coefficient matrix includes:
removing one or more estimated model coefficients from the coefficient matrix in response to the one or more estimated model coefficients failing to satisfy an adaptively generated coefficient pruning threshold.

9. The method of claim 8, further comprising:
determining a maximum absolute value of the estimated model coefficients included in the coefficient matrix;
determining a minimum absolute value of the estimated model coefficients included in the coefficient matrix; and
generating the pruning matrix of the coefficient pruning thresholds based on the maximum absolute value of the estimated model coefficients and the minimum absolute value of the estimated model coefficients.

10. The method of claim 9, further comprising:
during a first pruning iteration,
generating a first pruning matrix based on the maximum absolute value of the estimated model coefficients included in the coefficient matrix and the minimum absolute value of the estimated model coefficients included in the coefficient matrix;
generating a plurality of first sparsified coefficient matrices by applying each of the coefficient pruning thresholds included in the first pruning matrix to the estimated model coefficients of the coefficient matrix; and
selecting a selected sparsified coefficient matrix of the plurality of first sparsified coefficient matrices; and
during a second pruning iteration,
generating a second pruning matrix based on a maximum value of estimated model coefficients included in the selected sparsified coefficient matrix, a minimum value of the estimated model coefficients included in the selected sparsified coefficient matrix, and a density value;
generating a plurality of second sparsified coefficient matrices by applying each of the coefficient pruning thresholds included in the second pruning matrix to the estimated model coefficients of the selected sparsified coefficient matrix; and
selecting a selected second sparsified coefficient matrix of the plurality of second sparsified coefficient matrices to be used by the artificial intelligence model in predicting behavior of the physical system.

11. A method comprising:
generating, from a library matrix including a library of candidate model terms associated with a plurality of candidate models, a coefficient matrix including estimated model coefficients describing dynamic behavior of a physical system;
generating a plurality of sparsified coefficient matrices by removing one or more of the estimated model coefficients based on a matrix of sparsity enforcement thresholds;
selecting, based on a model-selection criterion that scales with a number of data points, a particular sparsified coefficient matrix of the plurality of sparsified coefficient matrices as optimally describing the dynamic behavior of the physical system; and
using the particular sparsified coefficient matrix to model behavior of the physical system.

12. The method of claim 11, wherein generating the coefficient matrix includes:
obtaining a state variable matrix including state variables associated with the physical system;
constructing a target matrix based on the state variables; and
obtaining the library of the candidate model terms as user input.

13. The method of claim 12, further comprising:
generating the coefficient matrix based on an equation of a form Ξ=Θ⁻¹Y, where Ξ is the coefficient matrix including the estimated model coefficients, Θ⁻¹ is a pseudoinverse of the library matrix including the library of the candidate model terms, and Y is the target matrix.

14. The method of claim 11, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.

15. The method of claim 11, wherein generating the plurality of sparsified coefficient matrices includes:
generating the matrix of the sparsity enforcement thresholds based on an absolute value of a maximum value of the estimated model coefficients, an absolute value of a minimum value of the estimated model coefficients, and a density value; and
generating a sparsified coefficient matrix based for each element in the matrix of the sparsity enforcement thresholds, each sparsified coefficient matrix being generated by removing any estimated model coefficients having a value exceeding a value of a corresponding element in the matrix of the sparsity enforcement thresholds.

16. A processing device comprising:
a memory storing a program of instructions; and
a processor coupled to the memory, and configured to execute the program of instructions to
obtain a target matrix;
obtain a library matrix including a library of candidate model terms associated with a plurality of candidate models;
generate, based on the target matrix and the library matrix, a coefficient matrix including estimated model coefficients;
prune the coefficient matrix based on a pruning matrix of coefficient pruning thresholds to generate at least one sparsified coefficient matrix; and
select one or more of the at least one sparsified coefficient matrix as a candidate to be used by an artificial intelligence model in predicting behavior of a physical system.

17. The processing device of claim 16, wherein the processor is further configured to execute the program of instructions to:
select the one or more of the at least one sparsified coefficient matrix based on a model-selection criterion that scales with a number of data points.

18. The processing device of claim 17, wherein the processor is further configured to execute the program of instructions to:
select a particular sparsified coefficient matrix as optimal based on the model-selection criterion.

19. The processing device of claim 17, wherein the processor is further configured to execute the program of instructions to select the one or more of the at least one sparsified coefficient matrix by ranking a plurality of sparsified coefficient matrices based on the model-selection criterion.

20. The processing device of claim 17, wherein the model-selection criterion includes:
a weighted sum of a*n*log(ê)+b*n*log(k), where a and b are positive real numbers, n is the number of data points, ê is a mean square error of the estimated model coefficients and k is a number of model parameters, with a*n*log(ê) related to data fit, and b*n*log(k) related to data sparsity.
